(19) United States
(12) Patent Application Publication
(10) Pub. No.: US 2010/0245687 A1
(43) Pub. Date: Sep. 30, 2010

(54) CONTROL DEVICE AND PROJECTOR

(75) Inventor: Makoto FUSE, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/730,508

(22) Filed: Mar. 24, 2010

(30) Foreign Application Priority Data
Mar. 25, 2009 (JP) 2009-073573

(51) Int. Cl. H04N 9/31

(52) U.S. Cl. 348/761; 348/E05.137; 348/E09.025

(57) ABSTRACT

A control device controlling a display device which has an image forming area containing plural pixels to form an image on the image forming area according to inputted image information, includes: a memory unit which stores input/output characteristics measured at plural points on the image forming area in advance and indicating correspondence between applied voltage and emission luminance for each of the plural points; and a control unit which controls operation of the image forming area based on the respective input/output characteristics.

### BACKGROUND

1. Technical Field

The present invention relates to a control device for controlling a display device, and a projector including the control device.

2. Related Art

A display apparatus for displaying images corresponding to image information is known. Examples of this type of display apparatus involve a display provided with liquid crystal panel, organic EL (electro-luminescence) panel, plasma panel or other panels, and a projector which modulates light emitted from a light source by a liquid crystal panel and projects the modulated light on a projection surface such as screen for image display.

According to the display apparatus, the input/output characteristics showing correspondence between the voltage level applied to the panel and the luminance of light released from the panel when the voltage of the corresponding level is applied are different for each panel.

More specifically, VT (applied voltage to transmissivity) characteristics as the input/output characteristics are different for each liquid crystal panel. Thus, correction which gives consideration to the VT characteristics (such as gamma correction) is required so as to prevent gradation difference between an image corresponding to inputted image information and an image formed by the liquid crystal panel based on the image information.

Considering this situation, the projector including the liquid crystal panel, for example, measures VT characteristics for each liquid crystal panel by using a luminance meter or the like during manufacture, and creates correction LUT (look up table) for each liquid crystal panel based on measurement data (for example, see JP-A-2001-238227). The projector having this structure can reduce the gradation difference by operating the liquid crystal panel according the correction LUT at the time of image formation.

However, the input/output characteristics are different not only for each panel but also for each position on an area of image formation (image forming area). For example, even when voltage of the same level is applied to respective pixels on the image forming area to form an image by the maximum amount of light emission from the respective pixels (white image), the amount of light emission differs according to the positions of the image forming area. This is caused by temperature unevenness produced by lower temperature at the periphery of the image forming area than the temperature at the center at the time of operation of the panel, and also by the thickness of the liquid crystal layer in case of the liquid crystal panel. The difference in the amount of light emission according to the positions produces deterioration of formed images such as color unevenness and luminance unevenness.

### SUMMARY

It is an advantage of some aspects of the invention to provide a control device and a projector capable of preventing deterioration of images.

A control device controlling a display device which has an image forming area containing plural pixels to form an image on the image forming area according to inputted image information according to a first aspect of the invention includes: a memory unit which stores input/output characteristics measured at plural points on the image forming area in advance and indicating correspondence between applied voltage and emission luminance for each of the plural points; and a control unit which controls operation of the image forming area based on the respective input/output characteristics.

Examples of the display device include liquid crystal panel, organic EL (electro-luminescence) panel, PDP (plasma display panel), CRT (cathode ray tube), and other various types of display device. When the liquid crystal panel is used, the input/output characteristics may be applied voltage to transmissivity (VT) characteristics of the liquid crystal panel.

According to this structure, the operation of the image forming area is controlled according to the respective input/output characteristics measured at the plural points on the image forming area in advance. That is, voltage at the time of the maximum luminance (voltage at the maximum luminance) is obtained for each of the areas corresponding to the points for measuring the input/output characteristics on the image forming area. According to this structure, voltages corresponding to the voltages at the maximum luminance obtained based on the input/output characteristics measured at the respective points are applied to the areas associated with the respective points for measuring the input/output characteristics on the image forming area for display of an image having the maximum luminance (white image) by the display device. In this case, luminance unevenness on the formed image can be reduced more than a structure which uses only the input/output characteristics for one point in the whole image forming area. Thus, deterioration of images formed by the display device can be reduced. Moreover, the contrast of the display device can be improved by forming the white image having further higher luminance.

It is preferable that the plural points are located substantially at the center and the corner of the image forming area.

The input/output characteristics at the center of the image forming area considerably differ from those at the corner due to the temperature unevenness or the like explained above. Thus, luminance difference between the center and the corner of the formed image is easily produced. According to this structure, however, the respective input/output characteristics measured substantially at the center and at the corner of the image forming area in advance are stored in the memory unit, and operation of the image forming area is controlled based on the input/output characteristics. Thus, luminance difference between the center and the corner of the formed image can be prevented. Accordingly, deterioration of images can be securely prevented.

It is preferable that the control device includes: a range setting section which sets voltage applying ranges at the plural points based on the input/output characteristics; and a drive control section which controls operation of areas corresponding to the plural points based on the set voltage applying ranges.

According to this structure, the range setting section sets voltage applying ranges according to the input/output characteristics, that is, based on applied voltage at the time of the minimum luminance (voltage at the minimum luminance) and applied voltage at the time of the maximum luminance (voltage at the maximum luminance). In this case, the drive control section controls operation of the areas corresponding to the respective points for measuring the input/output characteristics on the image forming area by converting voltages of the image signals inputted as image information or by other method based on the voltage applying ranges to make luminance of the respective areas substantially uniform. Thus, generation of luminance unevenness on the formed images can be further securely reduced, and deterioration of the images can be more securely prevented.

It is preferable that the control unit includes: an area dividing section which divides the image forming area into plural small areas; and a characteristics producing section which produces the input/output characteristics of a small area not containing the plural points in the small areas produced by the area dividing section based on the respective input/output characteristics stored in the memory unit.

According to this structure, the characteristics producing section produces the input/output characteristics of a small area whose input/output characteristics have not been measured based on the respective input/output characteristics measured and stored in advance. In this case, the control unit (such as the drive control section) operates the respective small areas of the image forming area based on the input/output characteristics stored in the memory unit and the produced input/output characteristics. Thus, generation of the luminance unevenness can be more securely reduced, and deterioration of the formed images can be further securely prevented.

A projector according to a second aspect of the invention includes: a light source device; a liquid crystal panel which modulates light emitted from the light source device; a projection device which projects the modulated light; and the control device described above. The display device includes the light source device, the liquid crystal panel, and the projection device. The control device controls the liquid crystal panel.

According to this structure, advantages similar to those of the control device described above can be offered.

The illuminance of light emitted from the light source device having a light source lamp and others on the plane orthogonal to the center axis of the light (in-plane illuminance) is high in the vicinity of the center axis of the light and decreases as the position of the illuminance shifts toward the periphery in some cases even when an equalizing illumination device for making the in-plane illuminance of the light substantially uniform is used. When such light enters the image forming area of the liquid crystal panel, the temperature at the center of the image forming area easily becomes high and the temperature at the periphery easily becomes low. In this case, the temperature unevenness is easily produced on the image forming area, and thus luminance difference between the center and the periphery of the formed images becomes large. According to the projector of the second aspect of the invention, the control unit controls operation of the liquid crystal panel based on the input/output characteristics measured at the plural points of the image forming area (applied voltage to transmissivity characteristics in this case). Thus, even when luminance unevenness is produced on the formed images, the luminance unevenness can be reduced. Accordingly, deterioration of images can be adequately prevented.

It is preferable that the projector further includes: a color division device which divides light emitted from the light source device into plural color lights; and a color combining device which combines the plural color lights. The liquid crystal panel is provided between the color division device and the color combining device for each of the plural color lights produced by the color division device. The memory unit stores the plural input/output characteristics for each of the liquid crystal panels. The control unit controls the respective liquid crystal panels based on the plural input/output characteristics for each of the liquid crystal panels.

According to this structure, the control device controls the respective liquid crystal panels for modulating the corresponding color lights based on the plural input/output characteristics stored for each of the liquid crystal panels. Thus, generation of luminance unevenness on the images formed by the liquid crystal panels can be prevented. By this method, generation of color unevenness on the image combined by the color combining device for combining the respective image lights can be prevented. Accordingly, deterioration of the formed images can be further appropriately reduced.

### BRIEF DESCRIPTION OF THE DRAWINGS

The invention will be described with reference to the accompanying drawings, wherein like numbers reference like elements.

FIG. 1 schematically illustrates a structure of a projector according to an embodiment of the invention.

FIG. 2 is a block diagram showing a structure of a control device according to the embodiment.

FIG. 3 shows measuring points for measuring VT characteristics on an image forming area according to the embodiment.

FIG. 4 is a graph showing a part of VT characteristics measured at the respective measuring points according to the embodiment.

FIG. 5 shows the image forming area divided into divisional areas according to the embodiment.

### DESCRIPTION OF EXEMPLARY EMBODIMENT

An embodiment according to the invention is hereinafter described.

### Structure of Projector

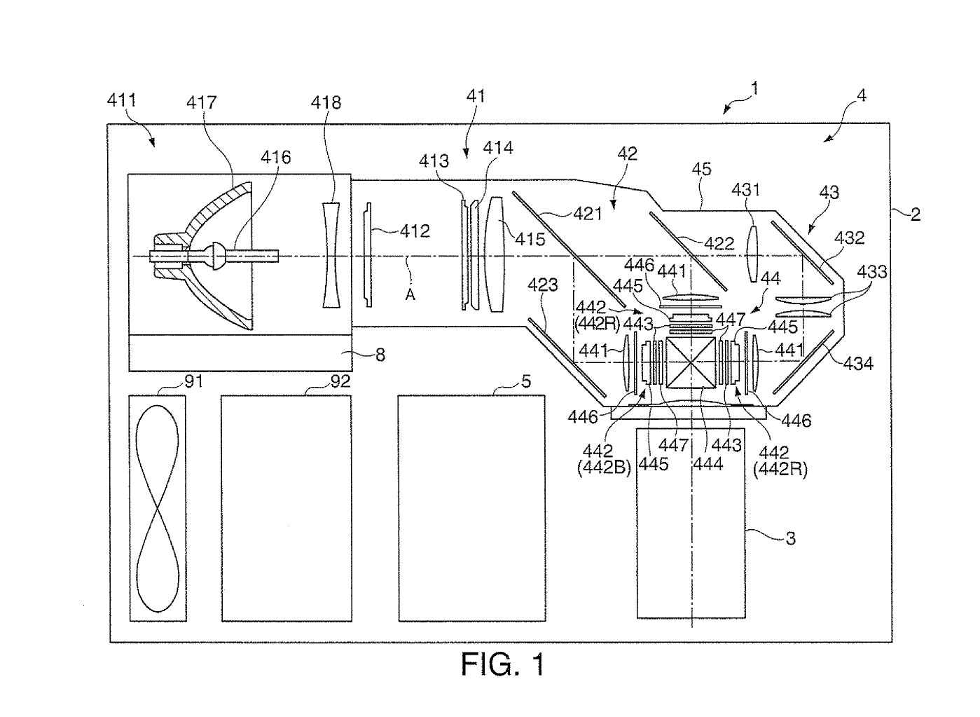

FIG. 1 schematically illustrates a structure of a projector 1 according to this embodiment.

The projector 1 in this embodiment forms image light by modulating light emitted from a light source device 411 provided inside the projector 1 corresponding to image information, and expands and projects the image light on a projection surface such as screen (not shown). As illustrated in FIG. 1, the projector 1 includes an outer housing 2, a projection device 3, an image forming device 4, and a control device 5.

The projector 1 further includes a cooling device 91 having a cooling fan and the like for cooling the interior of the projector 1, a power source device 92 for supplying power to the respective components provided inside the projector 1, and other units, all of which are disposed inside the outer housing 2.

### Structures of Outer Housing and Projection Device

The outer housing 2 for accommodating the projection device 3, the image forming device 4, the control device 5 and other units has substantially rectangular parallelepiped shape on the whole.

The projection device 3 forms an image of image light produced by the image forming device 4 on the projection surface, and expands and projects the image of the image light. The projection device 3 includes a combination of plural lenses contained in a cylindrical lens barrel. The projection device 3 and the image forming device 4 are units constituting a display device according to the embodiment of the invention.

### Structure of Image Forming Device

The image forming device 4 is an optical device for forming image light corresponding to image information under the control of the control device 5 described later. The image forming device 4 has substantially L-shape in the plan view extending along the back surface of the outer housing 2 and along the side surface of the outer housing 2. The image forming device 4 includes a uniform illumination device 41, a color division device 42, a relay device 43, and an electro-optical device 44, and an optical component housing 45 for accommodating these optical devices 41 through 44 and supporting and fixing the projection device 3 to a predetermined position.

The uniform illumination device 41 supplies substantially uniform illumination to image forming areas of liquid crystal panels 442 described later. The uniform illumination device 41 has the light source device 411, a pair of lens arrays 412 and 413, a polarization conversion element 414, and a superimposing lens 415.

The light source device 411 has a light source 416 for emitting light, a reflection mirror 417 for reflecting light emitted from the light source 416 and converging the light at a predetermined position, and a collimating lens 418 for collimating the light reflected and converged by the reflection mirror 417 such that the light travels in parallel with an illumination optical axis A. The light source 416 is constituted by a light source lamp such as extra-high pressure mercury lamp, or a solid light source such as LED (light emitting diode), for example.

The color division device 42 has dichroic mirrors 421 and 422, and a reflection mirror 423. The relay device 43 has an entrance side lens 431, relay lenses 433, and reflection mirrors 432 and 434.

The electro-optical device 44 has three field lenses 441, three liquid crystal panels 442 (red light liquid crystal panel 442R, green light liquid crystal panel 442G, and blue light liquid crystal panel 442B), three visibility angle compensators 443, and a cross dichroic prism 444 as color combining device.

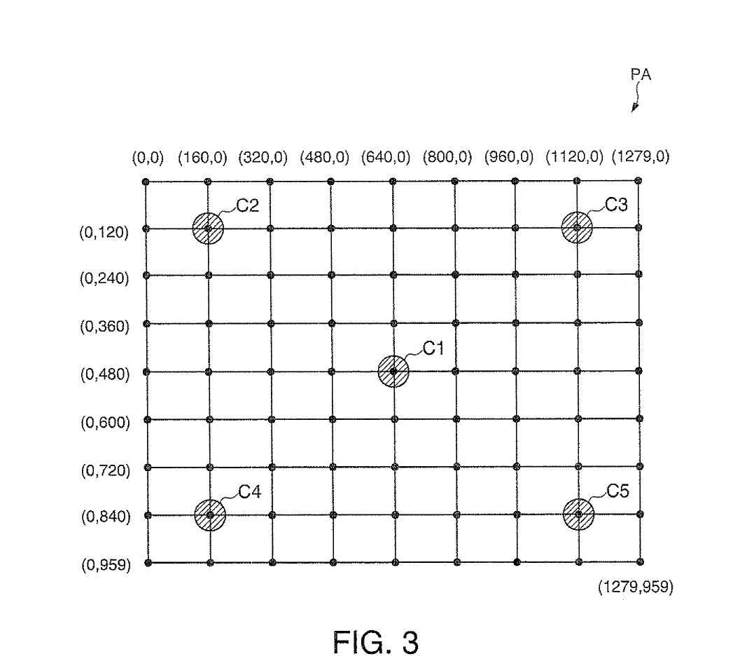

Each of the liquid crystal panels 442 is a normally white type liquid crystal panel having a liquid crystal element 445, and an entrance side polarization plate 446 and an exit side polarization plate 447 between which the liquid crystal element 445 is sandwiched. Each of the liquid crystal panels 442 has aspect ratio of 4:3, and includes an image forming area PA (FIG. 3) having 1,280 (horizontal direction)×960 (vertical direction) pixels, details of which will be described later.

In the image forming device 4 having this structure, light emitted from the uniform illumination device 41 and having uniform in-plane illuminance within the illumination area is divided into three color lights in R (red), G (green), and B (blue) by the color division device 42. The respective divisional color lights are modulated by the corresponding liquid crystal panels 442 according to image information to form image lights for the respective colors. Then, the image lights in respective colors are combined by the cross dichroic prism 444, and expanded and projected on the projection surface by the projection device 3.

### Structure of Control Device

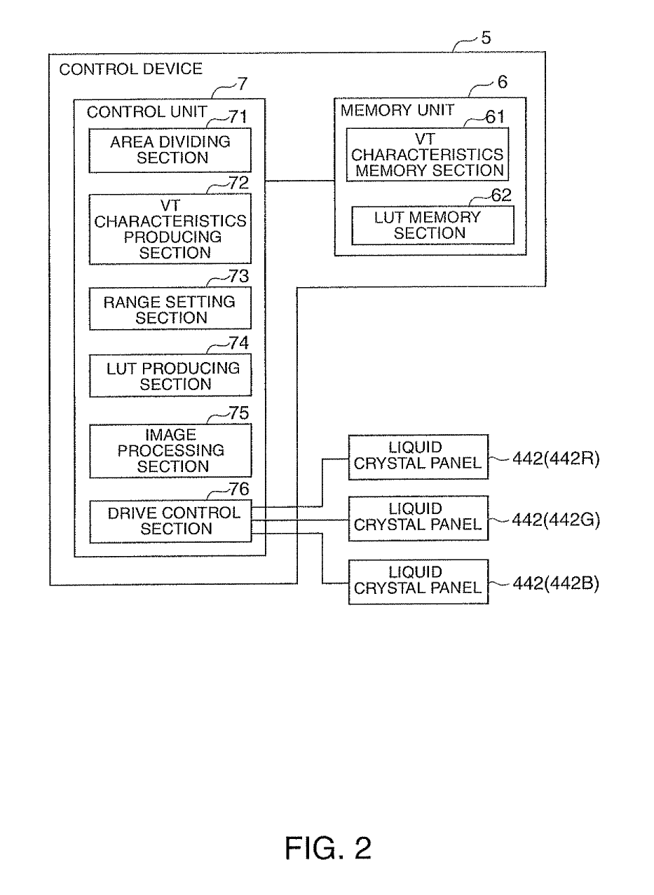

FIG. 2 is a block diagram showing the structure of the control device 5.

The control device 5 controls the overall operation of the projector 1 autonomously or in response to operation by a user. For example, the control device 5 controls ON and OFF of the light source device 411, and also produces drive signals corresponding to image signals as image information inputted to the projector 1 and outputs the drive signals to the liquid crystal panels 442 to form images corresponding to the image information. The control device 5 includes a memory unit 6 and a control unit 7.

### Structure of Memory Unit

The memory unit 6 has ROM (read only memory), flash memory and the like to store various programs and data necessary for processing by the control device 5. The memory unit 6 has a VT characteristics memory section 61 and an LUT memory section 62.

The LUT memory section 62 stores LUT (look up table) produced by an LUT producing section 74 of the control unit 7 for each of the liquid crystal panels 442. The details of the LUT will be described later.

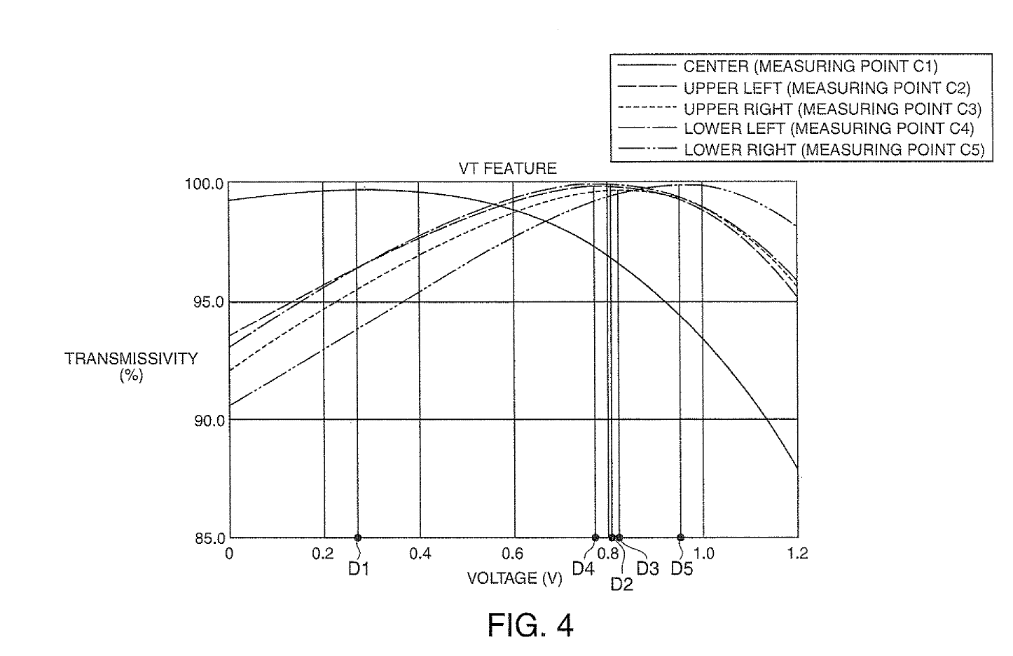

FIG. 3 shows measuring points C1 through C5 on the image forming area PA for measuring VT characteristics. FIG. 4 is a graph showing a part of VT characteristics (VT curves) measured at the measuring points C1 through C5.

The VT characteristics memory section 61 stores characteristics showing applied voltage to transmissivity (VT characteristics) as input/output characteristics indicating the level of applied voltage and the rate of transmissive light amount passing through the liquid crystal panels 442 when the corresponding level of voltage is applied with respect to the incident light amount for each of the liquid crystal panels 442. The VT characteristics memory section 61 stores VT characteristics at plural points on the image forming area PA for each of the liquid crystal panels 442.

According to this embodiment, the VT characteristics memory section 61 stores respective VT characteristics measured at the measuring point C1 positioned at the center of the image forming area PA, and at the four measuring points C2 through C5 in the vicinity of the four corners of the image forming area PA (for example, VT curves shown in FIG. 4) as shown in FIG. 3.

### Structure of Control Unit

Returning to FIG. 2, the control unit 7 as a circuit board on which a CPU (central processing unit) and other units are mounted controls the overall operation of the projector 1 according to the programs and data stored in the memory unit 6. The control unit 7 includes an area dividing section 71, a VT characteristics producing section 72, a range setting section 73, the LUT producing section 74, an image processing section 75, and a drive control section 76.

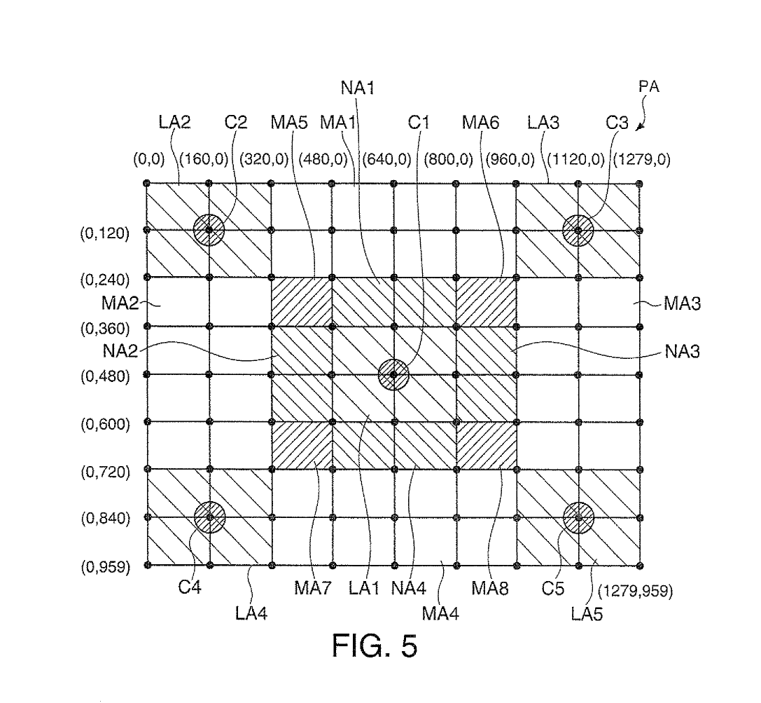

FIG. 5 shows the image forming area PA divided by the area dividing section 71.

The area dividing section 71 divides each of the image forming areas PA of the liquid crystal panels 442 into a plurality of small areas. In this embodiment, the area dividing section 71 divides the image forming area PA into 64 small areas in total each of which has 160 (horizontal direction)×120 (vertical direction) pixels as shown in FIG. 5.

Returning to FIG. 2, the VT characteristics producing section 72 corresponds to a characteristics producing section according to the embodiment of the invention. The VT characteristics producing section 72 extracts small areas whose VT characteristics have not been stored, and produces VT characteristics corresponding to these small areas based on VT characteristics stored in the VT characteristics memory section 61.

As shown in FIG. 5, an area LA1 containing coordinates (480, 360) to (799, 599), an area LA2 containing coordinates (0,0) to (319, 239), an area LA3 containing coordinates (960, 0) to (1279, 239), an area LA4 containing coordinates (0, 720) to (319, 959), and an area LA5 containing coordinates (960, 720) to (1279, 959) include the measuring points C1 through C5 explained above, respectively. Thus, the respective areas LA1 through LA5 have the corresponding VT characteristics measured at the measuring points C1 through C5, and the VT characteristics producing section 72 produces VT characteristics corresponding to small areas other than the areas LA1 through LA5 on the image forming area PA based on the VT characteristics measured at the measuring points C1 through C5.

More specifically, the VT characteristics producing section 72 produces VT characteristics corresponding to an area MA1 which contains coordinates (320, 0) to (959, 239) sandwiched between the areas LA2 and LA3 based on the VT characteristics of the areas LA2 and LA3, that is, the VT characteristics measured at the measuring points C2 and C3. Similarly, the VT characteristics producing section 72 produces respective VT characteristics corresponding to an area MA2 containing coordinates (0, 240) to (319, 719) sandwiched between the areas LA2 and LA4, an area MA3 containing coordinates (960, 240) to (1279, 719) sandwiched between the areas LA3 and LA5, an area MA4 containing coordinates (320, 720) to (959, 959) sandwiched between the areas LA4 and LA5 based on the VT characteristics measured at the measuring points C2 and C4, the measuring points C3 and C5, and the measuring points C4 and C5, respectively.

Moreover, the VT characteristics producing section 72 produces VT characteristics corresponding to an area MA5 containing coordinates (320, 240) to (479, 359) sandwiched between the areas LA1 and LA2 based on the VT characteristics of the areas LA1 and LA2, that is, the VT characteristics measured at the measuring points C1 and C2. Similarly, the VT characteristics producing section 72 produces respective VT characteristics corresponding to an area MA6 containing coordinates (800, 240) to (959, 359) sandwiched between the areas LA1 and LA3, an area MA7 containing coordinates (320,600) to (479, 719) sandwiched between the areas LA1 and LA4, an area MA8 containing coordinates (800, 600) to (959, 719) sandwiched between the areas LA1 and LA5 based on the VT characteristics measured at the measuring points C1 and C3, the measuring points C1 and C4, and the measuring points C1 and C5, respectively.

Furthermore, the VT characteristics producing section 72 produces VT characteristics corresponding to an area NA1 containing coordinates (480, 240) to (799, 359) sandwiched between the areas LA1 and MA1 based on the VT characteristics of the areas LA1 and MA1. Similarly, the VT characteristics producing section 72 produces respective VT characteristics corresponding to an area NA2 containing coordinates (320, 360) to (479, 599) sandwiched between the areas LA1 and MA2, an area NA3 containing coordinates (800,360) to (959, 599) sandwiched between the areas LA1 and MA3, an area NA4 containing coordinates (480, 600) to (799, 719) sandwiched between the areas LA1 and MA4 based on the VT characteristics of the areas LA1 and MA2, the areas LA1 and MA3, and the areas LA1 and MA4, respectively.

By this method, the respective VT characteristics of the areas LA1 through LA5, MA1 through MA8, and NA1 through NA4 on the image forming area PA are determined.

Returning to FIG. 2, the range setting section sets a gradation controllable voltage applying range for each of the areas LA1 through LA5, MA1 through MA8, and NA1 through NA4 based on the VT characteristics. More specifically, the range setting section 73 calculates applied voltage at the time of the maximum transmissivity (maximum luminance), i.e., the voltage at the maximum luminance, and applied voltage at the time of the minimum transmissivity (minimum luminance), i.e., the voltage at the minimum luminance based on the VT characteristics of the respective areas LA1 through LA5, MA1 through MA8, and NA1 through NA4, and sets the voltage applying range for each of the areas LA1 through LA5, MA1 through MA8, and NA1 through NA4 based on the respective calculated voltages.

For example, when VT characteristics at the measuring points C1 through C5 shown in FIG. 4 are stored, the range setting section 73 sets the voltages at the maximum luminance for the respective areas LA1 through LA5 at voltages corresponding to gradations D1 through D5. Thus, the voltages at the maximum luminance are different according to the areas LA1 through LA5, MA1 through MA8, and NA1 through NA4.

The LUT producing section 74 produces LUT showing correspondence between coordinates of pixels forming the image forming area PA and voltage applying ranges based on the voltage applying ranges of the LA1 through LA5, MA1 through MA8, and NA1 through NA4 for each of the liquid crystal panels 442. Then, the LUT producing section 74 stores the produced LUT in the LUT memory section 62.

The image processing section 75 converts image signals received from the outside into digital signals, and outputs the converted image signals to the drive control section 76.

The drive control section 76 corrects image signals inputted from the image processing section 75 and outputs the corrected image signals to the respective liquid crystal panels 442.

For example, the drive control section 76 performs gamma correction corresponding to gamma values stored in the memory unit 6 beforehand. At this time, the drive control section 76 refers to LUT for each of the liquid crystal panels 442 stored in the LUT memory section 62, and sets voltage corresponding to the corrected gradation (luminance) within the voltage applying ranges explained above. Then, the drive control section 76 converts voltages of R signal, G signal, and B signal contained in the image signal according to the set voltage, and outputs the converted signals to the corresponding liquid crystal panels 442R, 442G, and 442B.

Thus, when a white image is formed by the respective liquid crystal panels 442, voltage corresponding to the voltage at the maximum luminance set based on the corresponding VT characteristics is applied to each of the areas LA1 through LA5, MA1 through MA8, and NA1 through NA4 on the respective image forming areas PA of the liquid crystal panels 442. Then, substantially uniform red image, green image, and blue image are formed by the liquid crystal panels 442R, 442G, and 442B, and combined by the prism 444 to form a white image having reduced luminance unevenness and color unevenness.

The projector 1 according to this embodiment described above provides the following advantages.

The control unit 7 controls operation of the respective pixels on the image forming areas PA according to the VT characteristics measured at the measuring points C1 through C5 on the image forming areas PA in advance. According to this structure, voltages corresponding to the voltages at the maximum luminance calculated based on the VT characteristics measured at the measuring points C1 through C5 are applied to the areas LA1 through LA5 associated with the measuring points C1 through C5 on the respective image forming areas PA for display of a white image. In this case, luminance unevenness on the white image can be reduced more than a structure which stores only VT characteristics measured at the center (measuring point C1) on the image forming area PA. Thus, deterioration of formed images can be reduced.

The voltage at the maximum luminance based on the VT characteristics measured at the measuring point C1 is voltage corresponding to the gradation D1. However, each luminance measured at the measuring points C2 through C5 when the voltage of the gradation D1 is applied does not become the maximum luminance as shown in FIG. 4. However, when voltages corresponding to the gradations D2 through D5 based on the VT characteristics measured at the measuring points C2 through C5 are applied to the areas LA2 through LA5 associated with the measuring points C2 through C5, each luminance of the areas LA2 through LA5 becomes the highest possible luminance for output. Thus, a white image having higher luminance can be formed, and contrast can be increased.

The VT characteristics stored in the VT characteristics memory section 61 are VT characteristics measured at the measuring point C1 positioned at the center of the image forming area PA and at the measuring points C2 through C5 positioned at the four corners of the image forming area PA. According to this structure, operation of the image forming area PA is controlled based on the respective VT characteristics measured in advance at the center and the four corners of the image forming area PA as points producing large VT characteristics difference. Thus, generation of luminance unevenness on the formed white image can be securely prevented. Accordingly, deterioration of formed images can be securely reduced.

The in-plane illuminance of light emitted from the light source device 411 tends to decrease as the position of the illuminance shifts from the vicinity of the center axis of the light toward the periphery. In this case, the temperature at the center of the image forming area PA easily becomes higher than the temperature at the periphery. Thus, operation of liquid crystal molecules at the center of the image forming area PA differs from operation of liquid crystal molecules at the periphery, and great luminance difference is produced between the center and the periphery on the formed white image.

In this embodiment, the control unit 7 controls operation of the liquid crystal panels 442 based on the VT characteristics measured at the center and the four corners of each image forming area PA. Thus, even when luminance unevenness is produced on a formed image, the luminance unevenness can be reduced. Accordingly, deterioration of images can be adequately prevented.

The range setting section 73 determines voltage applying ranges on the respective areas LA1 through LA5, MA1 through MA8, and NA1 through NA4 based on VT characteristics. According to this structure, transmissivity (luminance) of the respective areas LA1 though LA5, MA1 through MA8, NA1 through NA4 can be made substantially uniform at the time of white image formation by converting voltages of inputted image signals based on the determined voltage applying ranges by the function of the drive control section 76. Thus, generation of luminance unevenness on the formed white image can be further securely prevented, and deterioration of the white image can be more securely reduced.

The VT characteristics producing section 72 produces VT characteristics of the areas MA1 through MA8 and NA1 through NA4 other than the areas LA1 through LA5 corresponding to the measuring points C1 through C5 on the image forming area PA based on the VT characteristics measured at the measuring points C1 through C5. According to this structure, the drive control section 76 controls operation of the respective areas LA1 through LA5, MA through MA8, and NA1 through NA4 based on the VT characteristics of the LA1 through LA5, MA1 through MA8, and NA1 through NA4. Thus, generation of the luminance unevenness discussed above can be more securely prevented, and deterioration of formed images can be further securely reduced.

The control unit 7 controls operation of the respective liquid crystal panels 442 based on the corresponding VT characteristics on the image forming areas PA contained in the VT characteristics measured at the measuring points C1 through C5 on the image forming areas PA of the liquid crystal panels 442 in advance. According to this structure, generation of luminance unevenness on images formed by the respective liquid crystal panels 442 can be prevented. Thus, color unevenness is prevented on an image combined by the prism 444, and deterioration of formed images can be further adequately reduced.

### Modified Example

While the particular embodiment of the invention has been shown and described herein, it is intended that the invention includes all modifications, improvements and the like of the embodiment without departing from the scope and spirit of the invention.

According to this embodiment, the measuring points C1 through C5 for measuring VT characteristics on the image forming area PA are located at the center and the four corners of the image forming area PA. However, the measuring points may be positioned at the center and any of the four corners, for example. In this case, the VT characteristics measured at the corresponding corner may be applied to the entire periphery of the image forming areas PA. Alternatively, each image forming area PA may be divided into small areas in matrix to store VT characteristics measured for the respective small areas. Thus, the measuring points for measuring VT characteristics may be any positions as long as they are located away from each other, and the number of the measuring points may be arbitrarily determined.

According to this embodiment, the VT characteristics of the areas MA1 through MA8 and NA1 through NA4 not containing the measuring points C1 through C5 are produced based on the VT characteristics measured at the measuring points C1 through C5. However, in case of a structure dividing each image forming area PA into small areas each of which contains a measuring point, each operation of the small areas may be controlled based on the VT characteristics measured at the measuring point contained in the corresponding small area. Alternatively, the VT characteristics of the areas MA1 through MA8 and NA1 through NA4 produced in advance based on the VT characteristics measured at the measuring points C1 through C5 may be stored in the VT characteristics memory section 61 beforehand.

According to this embodiment, each of the liquid crystal panels 442 has the image forming area PA constituted by 1280 (horizontal direction)×960 (vertical direction) pixels. However, the invention is not limited to this structure. For example, the resolution of the image forming areas may be arbitrarily selected, and the aspect ratio may be 16:9. While the area dividing section 71 divides each of the image forming areas PA into small areas having 160 (horizontal direction)×120 (vertical direction) pixels in this embodiment, the resolution and shape of the small areas may be arbitrarily selected. For example, the area dividing section 71 may divide each of the image forming areas PA into concentric areas each center of which is located at the center of the image forming area PA.

According to this embodiment, the projector 1 includes the three liquid crystal panels 442R, 442G, and 442B. However, the invention is applicable to a projector having two or smaller number, or four or larger number of liquid crystal panels.

While the image forming device 4 in this embodiment has substantially L shape in the plan view, the image forming device 4 may have other shapes such as substantially U shape in the plan view.

According to this embodiment, each of the transmission type liquid crystal panels 442 has the light entrance surface and the light exit surface separately. However, reflection type liquid crystal panels each of which has a surface functioning both as light entrance surface and light exit surface may be employed.

According to this embodiment, the front-type projector whose image light projection direction is substantially the same as the image observing direction of the image light has been discussed as an example. However, the invention is applicable to a rear-type projector whose projection direction and observing direction are opposite to each other.

According to this embodiment, the display device is constituted by the image forming device 4 having the liquid crystal panels 442, and the control device 5 controls the operation of the liquid crystal panels 442. However, the control device of the invention is applicable to a control device controlling operation of various types of display such as liquid crystal display, organic EL display, plasma display, and CRT display. In these cases, input/output characteristics indicate correspondence between applied voltage and luminance (light emission amount).

The invention is appropriately applied to a control device for controlling operation of various types of display panel.

The entire disclosure of Japanese Patent Application No. 2009-073573, filed Mar. 25, 2009 is expressly incorporated by reference herein.

What is claimed is:

1. A control device controlling a display device which has an image forming area containing plural pixels to form an image on the image forming area according to inputted image information, comprising:
a memory unit which stores input/output characteristics measured at plural points on the image forming area in advance and indicating correspondence between applied voltage and emission luminance for each of the plural points; and
a control unit which controls operation of the image forming area based on the respective input/output characteristics.

2. The control device according to claim 1, wherein the plural points are located substantially at the center and the corner of the image forming area.

3. The control device according to claim 1, wherein the control unit includes:
a range setting section which sets voltage applying ranges at the plural points based on the input/output characteristics; and
a drive control section which controls operation of areas corresponding to the plural points based on the set voltage applying ranges.

4. The control device according to claim 1, wherein the control unit includes:
an area dividing section which divides the image forming area into plural small areas; and
a characteristics producing section which produces the input/output characteristics of a small area not containing the plural points in the small areas produced by the area dividing section based on the respective input/output characteristics stored in the memory unit.

5. A projector, comprising:
a light source device;
a liquid crystal panel which modulates light emitted from the light source device;
a projection device which projects the modulated light; and
the control device according to claim 1,
wherein
the display device includes the light source device, the liquid crystal panel, and the projection device, and
the control device controls the liquid crystal panel.

6. The projector according to claim 5, further comprising:
a color division device which divides light emitted from the light source device into plural color lights; and
a color combining device which combines the plural color lights,
wherein
the liquid crystal panel is provided between the color division device and the color combining device for each of the plural color lights produced by the color division device,
the memory unit stores the plural input/output characteristics for each of the liquid crystal panels, and
the control unit controls the respective liquid crystal panels based on the plural input/output characteristics for each of the liquid crystal panels.

7. A projector, comprising:
a light source device;
a liquid crystal panel which modulates light emitted from the light source device;
a projection device which projects the modulated light; and
the control device according to claim 2,
wherein
the display device includes the light source device, the liquid crystal panel, and the projection device, and
the control device controls the liquid crystal panel.

8. The projector according to claim 7, further comprising:
a color division device which divides light emitted from the light source device into plural color lights; and
a color combining device which combines the plural color lights,
wherein
the liquid crystal panel is provided between the color division device and the color combining device for each of the plural color lights produced by the color division device,
the memory unit stores the plural input/output characteristics for each of the liquid crystal panels, and
the control unit controls the respective liquid crystal panels based on the plural input/output characteristics for each of the liquid crystal panels.

9. A projector, comprising:
a light source device;
a liquid crystal panel which modulates light emitted from the light source device;
a projection device which projects the modulated light; and
the control device according to claim 3,
wherein
the display device includes the light source device, the liquid crystal panel, and the projection device, and
the control device controls the liquid crystal panel.

10. The projector according to claim 9, further comprising:
a color division device which divides light emitted from the light source device into plural color lights; and
a color combining device which combines the plural color lights,
wherein
the liquid crystal panel is provided between the color division device and the color combining device for each of the plural color lights produced by the color division device,
the memory unit stores the plural input/output characteristics for each of the liquid crystal panels, and
the control unit controls the respective liquid crystal panels based on the plural input/output characteristics for each of the liquid crystal panels.

11. A projector, comprising:
a light source device;
a liquid crystal panel which modulates light emitted from the light source device;
a projection device which projects the modulated light; and
the control device according to claim 4,
wherein
the display device includes the light source device, the liquid crystal panel, and the projection device, and
the control device controls the liquid crystal panel.

12. The projector according to claim 11, further comprising:
a color division device which divides light emitted from the light source device into plural color lights; and
a color combining device which combines the plural color lights,
wherein
the liquid crystal panel is provided between the color division device and the color combining device for each of the plural color lights produced by the color division device,
the memory unit stores the plural input/output characteristics for each of the liquid crystal panels, and
the control unit controls the respective liquid crystal panels based on the plural input/output characteristics for each of the liquid crystal panels.
